(19) United States
(12) Patent Application Publication
(10) Pub. No.: US 2008/0196645 A1
(43) Pub. Date: Aug. 21, 2008

(54) Multimedia information selection apparatus, sewing machine, and multimedia information selection program and sewing program recorded on computer-readable recording medium

(75) Inventors: Masae Ikeba, Handa-shi (JP); Kenji Yamada, Nagoya-shi (JP)

Correspondence Address: OLIFF & BERRIDGE, PLC, P.O. BOX 320850, ALEXANDRIA, VA, 22320-4850, US

(73) Assignee: BROTHER KOGYO KABUSHIKI KAISHA, Nagoya-shi (JP)

(21) Appl. No.: 11/902,040

(22) Filed: Sep. 18, 2007

(30) Foreign Application Priority Data
Sep. 26, 2006 (JP) 2006-260364

(51) Int. Cl. D05B 19/02; G06F 19/00

(52) U.S. Cl. 112/470.01; 700/136

(57) ABSTRACT

A multimedia information selection apparatus includes a memory that stores a plurality of multimedia information including at least one of sound information, moving image information, and still image information to be played in a sewing machine that performs sewing based on sewing data for forming stitches on a work cloth and stores the sewing data and unique information added for each of the sewing data and a controller that selects one of the sewing data stored in the sewing data storage device and selects the multimedia information corresponding to the sewing data selected from among the plurality of multimedia information stored based on the unique information added to the selected sewing data.

### CROSS-REFERENCE TO RELATED APPLICATION

This Application claims priority from JP 2006-260364, filed Sep. 26, 2006, which is hereby incorporated by reference in its entirety.

### BACKGROUND

The present disclosure relates to a multimedia information selection apparatus, a sewing machine, and a multimedia information selection program and a sewing machine program which are recorded on a computer-readable recording medium.

Conventionally, a sewing machine is known which sews a desired pattern automatically. This type of sewing machine is equipped with sewing means that forms stitches on a work cloth and control means which controls the sewing means. A user selects a desired pattern by using a touch panel, for example, provided on the sewing machine and the sewing means is controlled by the control means so that the pattern selected by the user is sewn automatically. However, such a sewing machine has the disadvantage that when the sewing is being carried out automatically, the user can only passively watch sewing operations of the sewing machine and cannot sufficiently enjoy sewing.

Consequently, a sewing machine is proposed which plays music through a speaker provided on the body when sewing is being performed (see, for example, Japanese Patent Application Laid-Open Publication No. Hei 3-173598). This sewing machine includes a plurality of music data pieces stored beforehand in sound generation information storage means. A user can select a piece of music data to be played during sewing, and as a result, this sewing machine can not only sew a pattern automatically, but can also play music for the user's enjoyment.

Another sewing machine which uses sound to notify a user of an operating state, contents of user's operations and the like, is proposed (see, for example, Japanese Patent Application Laid-Open Publication No. Sho 57-125793). If a fault occurs on this type of sewing machine or the user makes a wrong operation, the user is notified of the fault or wrong operation by sounds, thereby allowing the user to quickly and properly carry out a recovery operation, and the like, to deal with the problem.

### SUMMARY

However, the above-described conventional sewing machines are troublesome to operate because the user must select one piece among a plurality of music data pieces stored beforehand. In addition, these conventional sewing machines have the added problem that listening to the same music or sound becomes monotonous to the user.

It is an object of the present disclosure to provide a multimedia information selection apparatus that allows for simple and appropriate selection of music, sounds, moving images, and still images that correspond to a pattern being sewn, a sewing machine equipped with the multimedia information selection apparatus, and a multimedia information selection program and a sewing machine program which are recorded on a computer-readable recording medium.

The present disclosure provides a multimedia information selection apparatus that includes a memory that stores a plurality of multimedia information including at least one of sound information, moving image information, and still image information to be played in a sewing machine that performs sewing based on sewing data for forming stitches on a work cloth and stores the sewing data and unique information added for each of the sewing data, and a controller that selects one of the sewing data stored, and selects the multimedia information corresponding to the sewing data selected from among the plurality of multimedia information stored based on the unique information added to the selected sewing data.

The present disclosure further provides a sewing machine that comprises a multimedia information selection apparatus including a memory that stores a plurality of multimedia information including at least one of sound information, moving image information, and still image information to be played in a sewing machine that performs sewing based on sewing data for forming stitches on a work cloth and stores the sewing data and unique information added for each of the sewing data, and a controller that selects one of the sewing data stored, and selects the multimedia information corresponding to the sewing data selected from among the plurality of multimedia information stored based on the unique information added to the selected sewing data, a sewing device that forms the stitches on the work cloth, and a playing device that plays the multimedia information, wherein the controller controls the sewing device based on the sewing data selected and controls the playing device to play the multimedia information selected throughout the time the sewing device is being driven.

The present disclosure further provides a multimedia information selection program encoded on a computer-readable medium comprising instructions for selecting one sewing data for forming stitches on a work cloth, and selecting multimedia information corresponding to the sewing data selected from among a plurality of multimedia information including at least one of sound information, moving image information, and still image information to be played in a sewing machine that performs sewing based on the sewing data, based on unique information added to the selected sewing data.

The present disclosure further provides a sewing machine program encoded on a computer-readable medium comprising instructions for selecting one sewing data for forming stitches on a work cloth, selecting multimedia information corresponding to the sewing data selected from among a plurality of multimedia information including at least one of sound information, moving image information, and still image information to be played in a sewing machine that performs sewing based on the sewing data, based on unique information added to the selected sewing data, forming the stitches on the work cloth based on the sewing data selected, and playing the multimedia information selected throughout the time the stitches are being formed.

As should be appreciated, the use of the terms “means”, “device”, “structure” and other similar terms should be considered synonyms according to the present disclosure.

### BRIEF DESCRIPTION OF THE DRAWINGS

Exemplary embodiments of the present disclosure will be described below in detail with reference to the accompanying drawings in which:

FIG. 1 is an external view of a sewing machine;

FIG. 2 is a right side view of the sewing machine;

FIG. 3 is a block diagram showing an electrical configuration of the sewing machine;

FIG. 4 is a conceptual diagram showing storage areas of a ROM;

FIG. 5 is a conceptual diagram showing a configuration of embroidery data;

FIG. 6 is a conceptual diagram showing one example of a storage configuration of stored music data in a music data storage area of the ROM;

FIG. 7 is a flowchart of music data playing process performed in the sewing machine;

FIG. 8 is a flowchart of a playlist preparation process, which is a subroutine of the music data playing process shown in FIG. 7;

FIG. 9 is an illustration showing one example of an embroidery data selection screen;

FIG. 10 is a conceptual diagram showing a configuration of the embroidery data;

FIG. 11 is a flowchart of a music data playing process performed in the sewing machine;

FIG. 12 is a flowchart of the playlist preparation process by thread color, which is a subroutine of the music data playing process shown in FIG. 11;

FIG. 13 is a conceptual diagram showing one example of a storage configuration of stored sound data in a sound data storage area of the ROM;

FIG. 14 is a flowchart of a sound data playing process performed in the sewing machine;

FIG. 15 is a flowchart of a playlist preparation process performed in the sewing machine; and

FIG. 16 is an illustration showing one example of a music data selection screen.

### DETAILED DESCRIPTION OF THE EMBODIMENTS

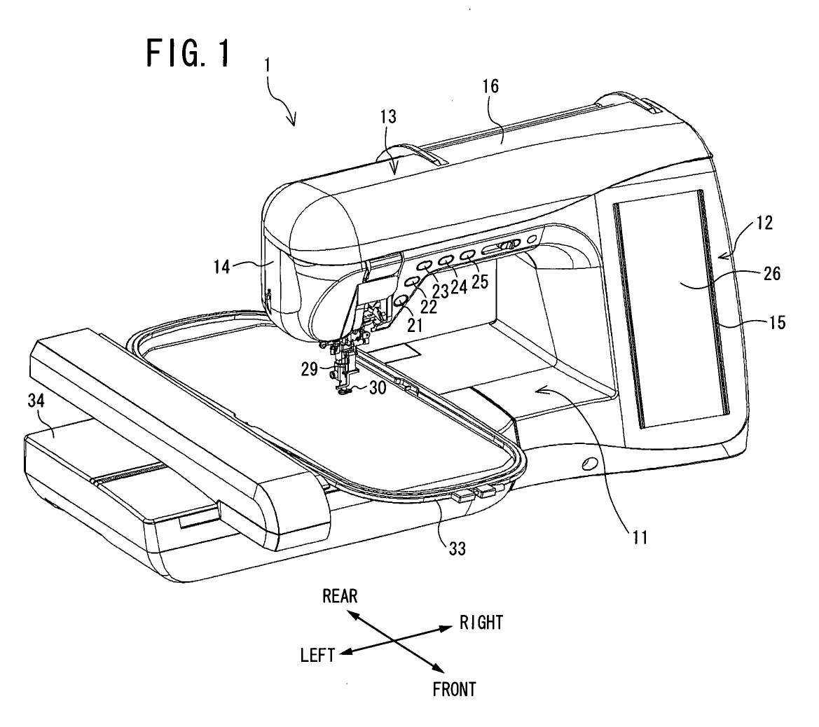

The present disclosure will be described in detail through reference to the drawings. Referring to FIG. 1, a sewing machine 1 according to an embodiment of the present disclosure will be described. The sewing machine 1 includes embroidery data stored in a ROM 62 in the sewing machine 1, the embroidery data to be selected by a user. Based on category information added to the selected embroidery data, a playlist of multimedia information is created. In accordance with the playlist, the multimedia information is played while sewing is carried out. The multimedia information includes sound information, moving image information and still image information. Aspects of a storage method of each type of information, a selection method of playing each type of information, start or stop timing of playing each type of information and the like are the same. Accordingly, the following will describe processing with music data comprised of sound information. It should be noted, however, that embodiments of the present disclosure are not limited to sound information and include other types of information.

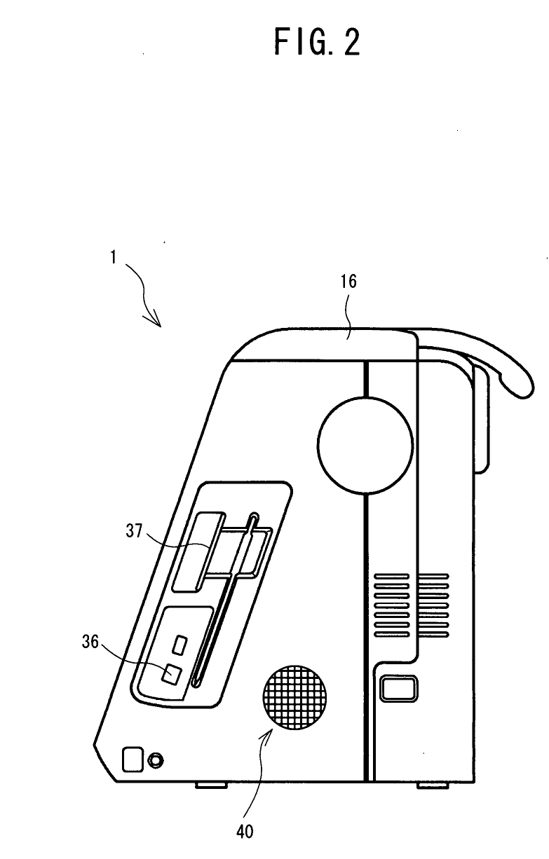

First, an overview of the sewing machine 1 is described with reference to FIGS. 1 and 2. As shown in FIG. 1, the sewing machine 1 has a horizontally long sewing machine bed 11, a pillar 12 erected upward from a right end of the sewing machine bed 11, and an arm portion 13 extending leftward from a top of the pillar 12. Further, a head portion 14 is provided to a left end of the arm portion 13.

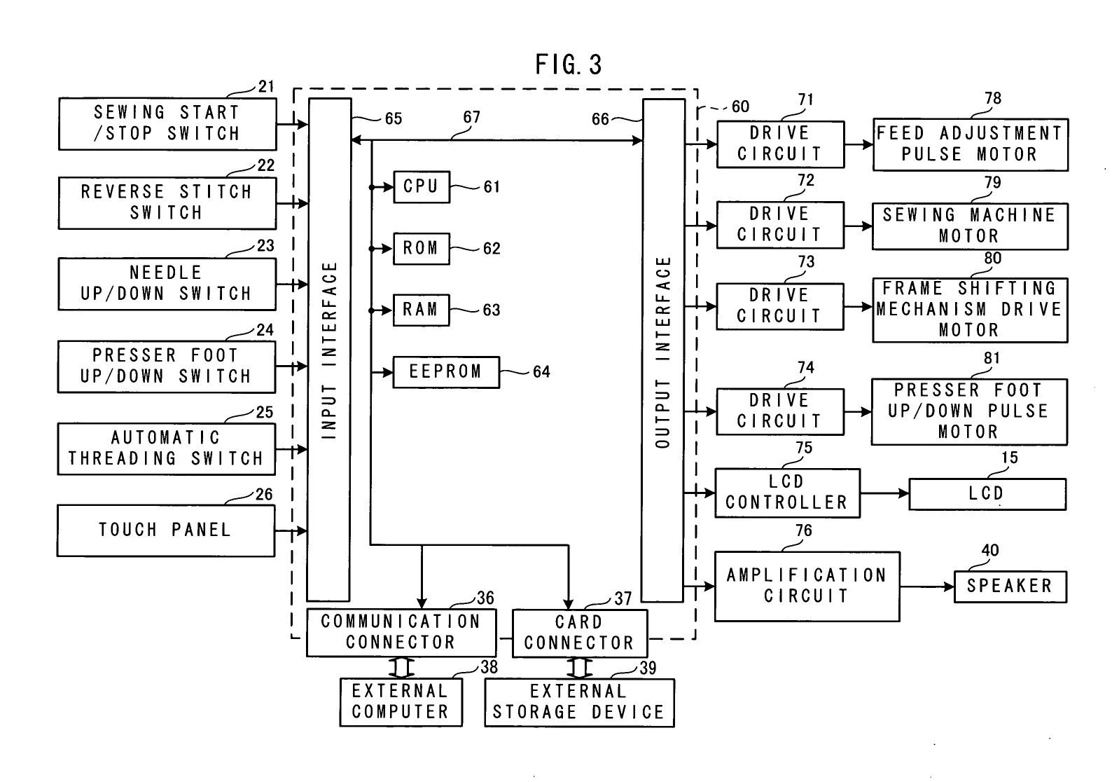

The sewing machine bed 11 is provided with a needle plate (not shown) arranged on an upper surface of the sewing machine bed 11 and a feed dog (not shown) provided at a lower side of the needle plate and used to feed a work cloth subject to sewing by a predetermined feed distance. The sewing machine bed 11 is further provided with a cloth feed mechanism (not shown) which drives the feed dog, a feed adjustment pulse motor 78 (see FIG. 3) which adjusts a feed distance, and a shuttle mechanism (not shown). Further, for sewing of an embroidery pattern, an embroidery equipment 34 is mounted to the sewing machine bed 11. The embroidery equipment 34 comprises an embroidery frame 33 which stretches and holds work cloth, a carriage (not shown) which mounts the embroidery frame 33 detachably, and a frame shifting mechanism (not shown) which shifts the embroidery frame 33 via the carriage in a predetermined direction in accordance with an embroidery pattern to be sewn. The embroidery equipment 34 further comprises a frame shifting mechanism drive motor 80 (see FIG. 3) which drives the frame shifting mechanism.

The head portion 14 is equipped with a thread take-up mechanism (not shown) and a needle bar mechanism (not shown) which drives a needle bar vertically (not shown). A sewing needle 29 is added to the needle bar. Operations of the above-described mechanisms are controlled by a control unit comprising a microcomputer built in the sewing machine 1 and the like. The head portion 14 is further equipped with an automatic thread hooking apparatus, an automatic threading mechanism, and the like. Behind the needle bar, a pressure bar (not shown) is provided for holding a presser foot 30 which presses a work cloth.

On a front face of the pillar 12, an LCD (liquid crystal display) 15 is provided which has a vertically long rectangular shape. The LCD 15 indicates a variety of patterns, function names to implement various functions required in sewing, a multimedia information selection screen, and a variety of messages including moving images and still images. Further, on the front surface of the LCD 15, a touch panel 26 is provided to accommodate display positions of selection buttons and the like on the selection screen and numeric settings and the like on various setting screens. The selection buttons on the selection screen include selection buttons for pattern names of a plurality of patterns, function names to perform various functions, and embroidery data. The numeric settings on the various setting screens include a feed distance of a work cloth by the feed adjustment pulse motor 78 (see FIG. 3). It is thus possible to select a pattern to be sewn, indicate the function to be performed, select multimedia information, set various numerals, and the like, by pressing the corresponding image displayed on the touch panel 26 of the LCD 15 using a pressing device such as a finger or a dedicated touch pen.

Also, as shown in FIG. 2, on a right side face of the pillar 12 are provided a speaker 40 which generates sounds and a communication connector 36 which connects an external computer and the sewing machine 1 to enable sending and receiving of data. Further, on the right side face of the pillar 12 is provided a card connector 37 to which an external ROM card containing stored embroidery data, multimedia information, and the like is connected.

As shown in FIG. 1, the arm portion 13 is provided with a cover 16 which opens and closes the upper side of the arm portion. The cover 16 runs along a longer direction of the arm portion 13 and can be opened and closed around a rotation axis (not shown) which extends horizontally at the upper rear end of the arm portion 13. Inside the cover 16, a thread spool (not shown) is housed which supplies a thread to the sewing machine 1. A needle thread extending from the thread spool, although not shown, goes through a plurality of thread hooking portions such as a tensioner and a thread take-up spring for adjustment of thread tension, a thread take-up lever, which pulls out the needle thread by moving vertically, and the like, to be supplied to the sewing needle 29 attached to the needle bar.

Further, inside the arm portion 13, a drive shaft (not shown) is provided which extends in the longer direction of the arm portion 13 and is driven rotationally by a sewing machine motor 79 (see FIG. 3). When the drive shaft revolves, the needle bar mechanism, the thread take-up mechanism, the cloth feed mechanism, and the shuttle mechanism, which are not shown, are driven.

Further, at a lower part of the front surface of the arm portion 13 are provided a sewing start/stop switch 21, a reverse stitch switch 22, a needle up/down switch 23, a presser foot up/down switch 24, an automatic threading switch 25, and the like. The sewing start/stop switch 21 is used to start and stop a sewing operation of the sewing machine 1. The reverse stitch switch 22 is used to feed a work cloth from rear side to front side, that is, in a direction opposite to the normal feeding direction. The needle up/down switch 23 is used to switch a needle bar stop position between upper and lower positions. The presser foot up/down switch 24 is used to raise or lower a presser foot 30. The automatic threading switch 25 is used to direct automatic threading for leading upper thread through the thread take-up lever, the tensioner, and the thread take-up spring and finally for threading the sewing needle 29.

Next, an electrical configuration of the sewing machine 1 will be described with reference to FIG. 3. As shown in FIG. 3, a control portion 60 of the sewing machine 1 includes a CPU 61, a ROM 62, a RAM 63, an EEPROM 64, an input interface 65, an output interface 66, the communication connector 36, the card connector 37, and the like, which are interconnected by a bus 67. Further, the sewing start/stop switch 21, the reverse stitch switch 22, the needle up/down switch 23, the presser foot up/down switch 24, the automatic threading switch 25, the touch panel 26, and the like are connected to the input interface 65. A drive circuit 71 which drives the feed adjustment pulse motor 78, a drive circuit 72 which drives the sewing machine motor 79, a drive circuit 73 which drives a frame shifting mechanism drive motor 80, and a drive circuit 74 which drives a presser foot up/down pulse motor 81 are connected to the output interface 66. The motors 78-81 are driven by signals transmitted from the control portion 60. Further, the LCD 15 is connected to the output interface 66 via a display controller 75 and the speaker 40 is connected to the output interface 66 via an amplification circuit 76. It should be noted that the EEPROM 64 is a nonvolatile memory and capable of rewriting contents electrically and holding stored contents even when there is no application of power.

Next, the CPU 61 will be described in detail. The CPU 61 conducts main control of the sewing machine 1, to perform various kinds of calculations and processing in order to carry out sewing in accordance with a control program stored in the ROM 62. The CPU 61 further controls the sewing machine 1 to display various moving images and still images comprised of multimedia information on the LCD 15, selects multimedia information to be played when sewing is being performed, and the like.

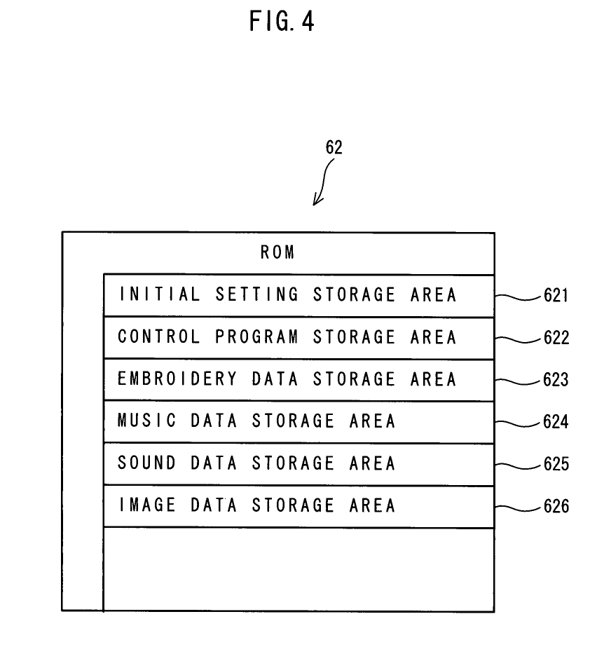

Referring to FIG. 4, the ROM 62 is provided with an initial setting storage area 621, a control program storage area 622, an embroidery data storage area 623, a music data storage area 624, a sound data storage area 625, an image data storage area 626, and the like. The initial setting storage area 621 stores initial values which are stored in the other storage areas. The control program storage area 622 stores various programs used to control operations of various drive mechanism and the operations of the sewing machine 1 such as selecting embroidery data and multimedia information, playing multimedia information, and the like. The embroidery data storage area 623 stores embroidery data comprised of stitch data, and category information and header information added for each stitch data. The music data storage area 624 stores a plurality of music data including music data classified into categories. The sound data storage area 625 stores a plurality of sound data including sound data classified into categories. The image data storage area 626 stores a plurality of image data of still images and moving images. The ROM 62 further has various storage areas, not shown.

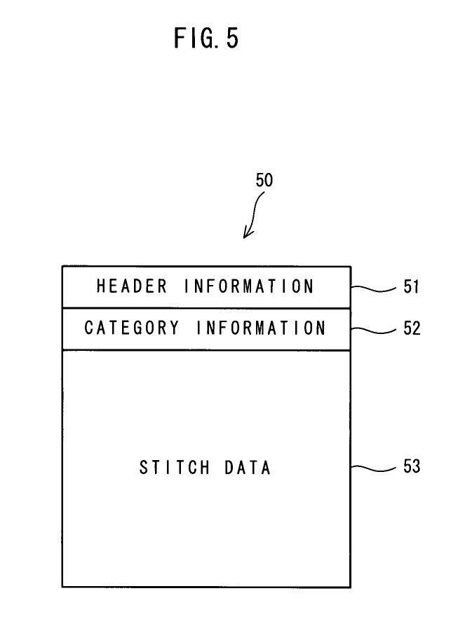

Next, embroidery data 50 stored in the embroidery data storage area 623 of the ROM 62 will be described in detail with reference to FIG. 5. As shown in FIG. 5, the embroidery data 50 comprises header information 51 related to the data and added to the head of the embroidery data and category information 52 indicating the category to which the embroidery data 50 belongs. The category information 52 is added for each of the embroidery data 50 when the embroidery data 50 is created, and is used to determine multimedia information to be played by the sewing machine 1 during sewing, details of which will be described later. Furthermore, the embroidery data 50 includes stitch data 53 which is necessary to form stitches on the work cloth and has added information about sewing time required for sewing.

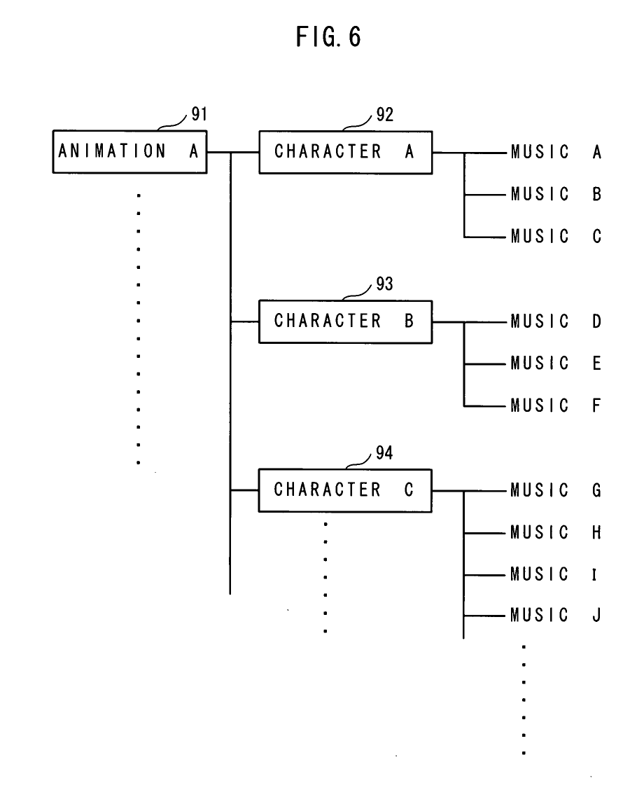

Next, music data stored in the music data storage area 624 of the ROM 62 according to the present embodiment of the present disclosure, will be described with reference to FIG. 6. As shown in FIG. 6, music data, which is multimedia information, is classified into a plurality of categories beforehand and stored. For example, a category 91 of animation A in which a plurality of characters appear is further classified into a plurality of categories corresponding to each character appearing in animation A, such as a category 92 of character A, a category 93 of character B, a category 94 of character C, and the like. That is, the categories form a hierarchy structure to form a category group. Moreover, music data corresponding to the classified categories 92-94 of the characters are stored. The plurality of category groups, as shown in FIG. 6, is stored in the music data storage area 624. Further, information about playing time is added to each music data.

According to the present embodiment of the present disclosure, music data to be output to the speaker 40 (see FIGS. 2 and 3) is selected on the basis of the category information 52 (see FIG. 5) added to the embroidery data 50 selected by a user. More specifically, if “character A” is specified on the basis of the category information 52 in the embroidery data 50, music data pieces A through C included in the category 92 of character A are played. If “animation A” is specified on the basis of the category information 52 in the embroidery data 50, all the music data pieces included in the category 91 of animation A, that is, music data pieces A through J, and all music data pieces included in the category 92 of character A through the category 94 of character C, and the like are played. That is, the category information 52 in the embroidery data 50 is associated with a category stored in the music data storage area 624.

Next, storage areas of the RAM 63 will be described. The RAM 63 is a storage element that can be read and written as necessary and provided with a variety of storage areas to store data read from the ROM 62, various settings read from the EEPROM 64, calculation results processed by the CPU 61, and the like. More specifically, the storage areas include a pattern data storage area which stores pattern data read from the ROM 62 and category information and header information which are added to the pattern data, a music data storage area, a sound data storage area, an image data storage area, a random number storage area, a multimedia information playlist storage area, and the like.

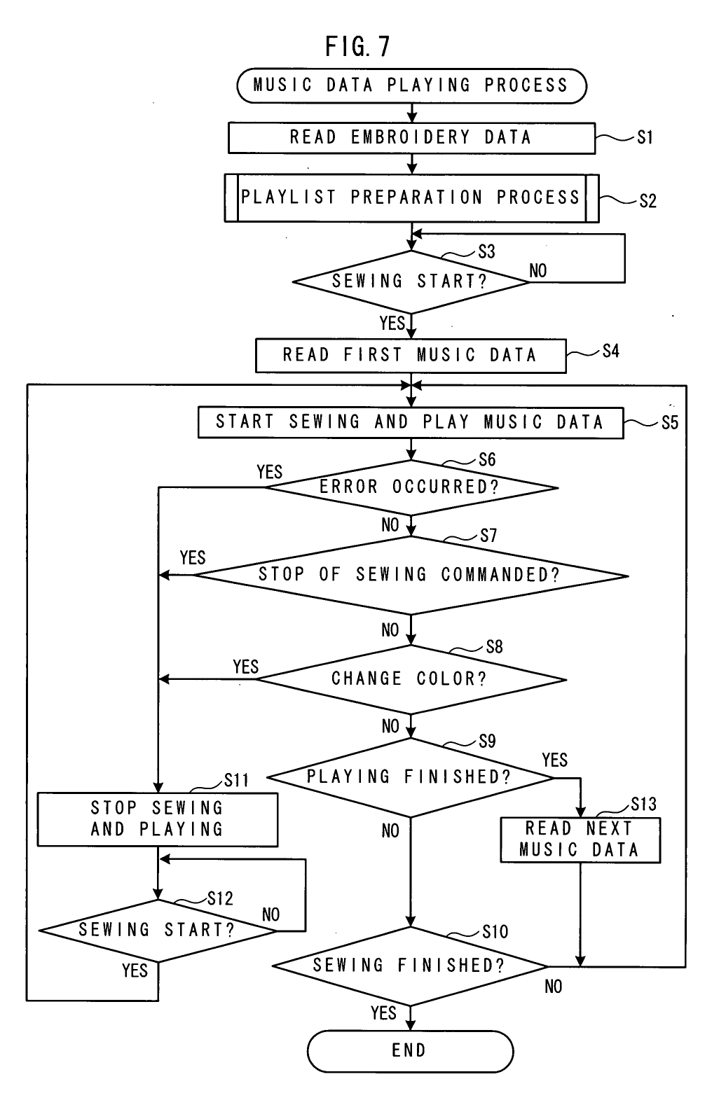

Next, operations of the sewing machine 1 in accordance with the present embodiment of the present disclosure will be described with reference to FIGS. 7 through 9. Hereinafter, steps of a flowchart are abbreviated as “S”.

As described earlier, in the sewing machine 1, a playlist of music data, which is multimedia information, is created on the basis of the category information 52 added to the embroidery data 50 selected by the user. In accordance with the playlist, the music data is played while sewing is carried out. Control of the sewing machine 1 is implemented by the control program stored in the control program storage area 622 of the ROM 62 and executed by the CPU 61.

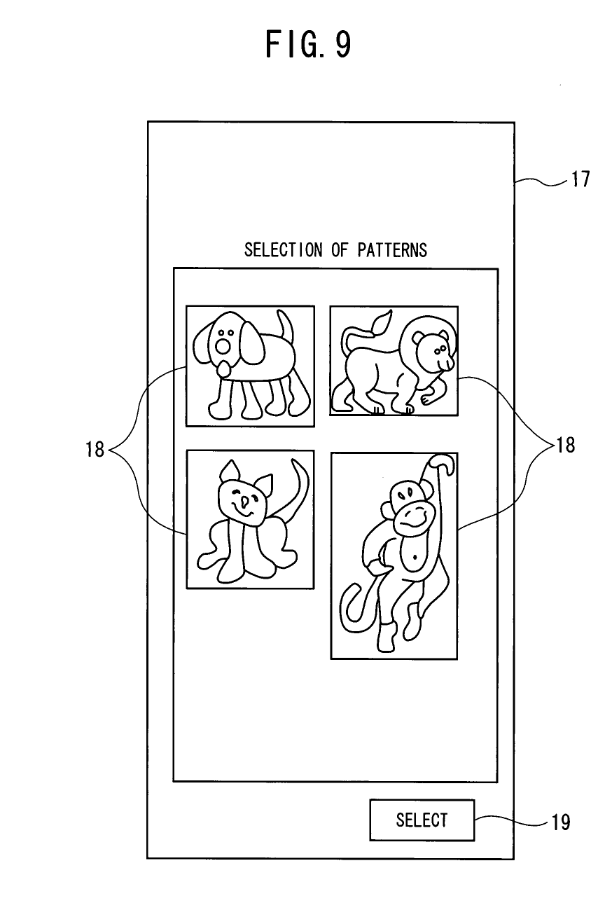

When the user operates the touch panel 26 to select one of a plurality of embroidery data 50 stored in the embroidery data storage area 623 of the ROM 62, the music data playing process shown in a flowchart of FIG. 7 starts. The embroidery data 50 is selected when the user selects a thumbnail image 18 that corresponds to the desired embroidery data 50 and operates a selection button 19 while the embroidery data selection screen 17 (see FIG. 9) is displayed on the LCD 15. As shown in the flowchart of FIG. 7, when the music data playing process starts, first, reading of the embroidery data 50 selected by the user is conducted (S1). As described earlier, the embroidery data 50 is comprised of the header information 51, the category information 52, and the stitch data 53 (see FIG. 5). In this step, the stitch data 53 and the category information 52 are read and stored in the RAM 63. Then, the playlist preparation process is conducted to determine the order of the music data to be played (S2).

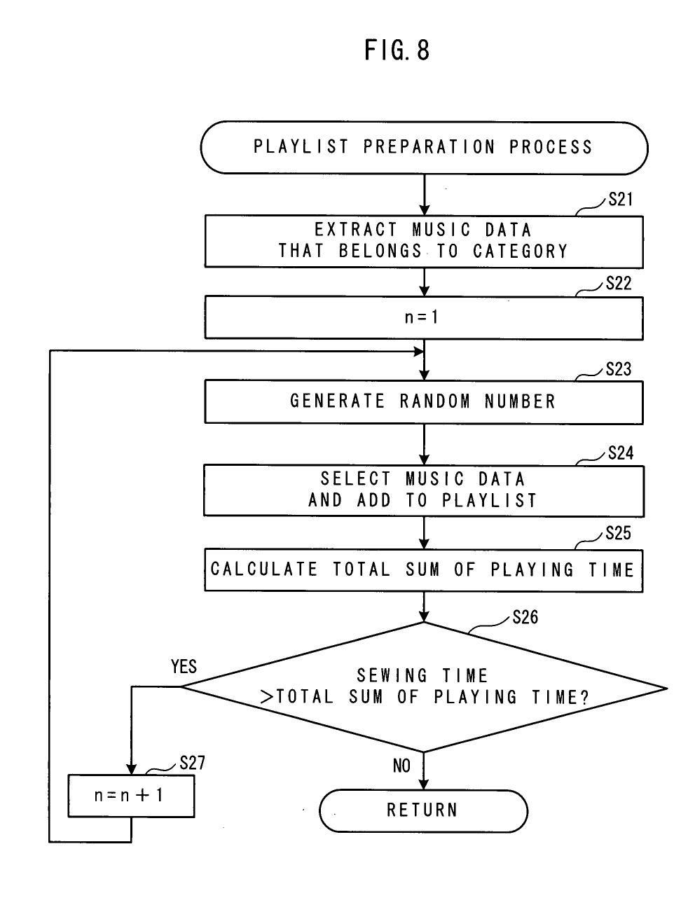

The playlist preparation process will be described in detail with reference to FIG. 8. As shown in the flowchart of FIG. 8, when the playlist preparation process is started, first, the music data that belongs to a category that matches the category information 52 added to the selected embroidery data 50 is extracted from a plurality of categories stored in the music data storage area 624 of the ROM 62 (S21). Consequently, candidates for the music data to be played are selected. Subsequently, the value of a counter n indicating music order in the playlist is initialized to an initial value of “1” (S22), then a random number generation process is performed and a generated random number is stored in the RAM 63 (S23). One of the music data contained in the extracted category corresponding to the stored random number is selected and added to the playlist as music data to be played n'th in the order (S24). This playlist is stored in the RAM 63.

Subsequently, based on information about playing time added to the respective music data, a total sum of the playing time of all of the music data pieces added to the playlist is calculated (S25). Subsequently, it is determined whether the calculated total sum of the playing time is less than a sewing time added to the sewing data 53 in the embroidery data 50 (S26). If it is determined that the total sum of the playing time is less than the sewing time (YES at S26), the counter n is incremented by one in order to add new music data to the playlist (S27) and the process returns to S23. As long as the total sum of the playing time is less than the sewing time, new music data is added to the playlist (S23-S25). When the total sum of the playing time is not less than the sewing time (NO at S26), the playlist preparation process is completed and returned to the music data playing process (see FIG. 7).

Subsequently, as shown in the flowchart of FIG. 7, it is determined whether there is a command to start sewing based on whether the sewing start/stop switch 21 (see FIGS. 1 and 3) is operated (S3). This determination is repeated until the sewing start/stop switch 21 is operated (NO at S3) and, when it is determined that there is a command to start sewing (YES at S3), the first music data in the prepared playlist is read from the RAM 63 (S4). Then, the above-described needle bar mechanism, the thread take-up lever (not shown), and the like are controlled to start sewing by use of the stitch data 53 in the embroidery data 50, and the music data is played through the speaker 40 (S5).

Subsequently, whether an error has occurred is determined (S6). If an error has occurred, such as the remaining quantity of a bobbin thread gets low, and the needle thread is cut off during sewing for any reason, the sewing machine 1 enters an error situation. If an error has occurred (YES at S6), sewing and playing of the music data are stopped (S11) and it is determined whether there is a command to start sewing (S12). Similar to the determination at S3, this determination is made based, on the sewing start/stop switch 21 is operated and is repeated until it is determined that there is a command to start sewing (NO at S12). If it is determined that there is a command to start sewing (YES at S112), the process returns to S5.

On the other hand, if no error has occurred (NO at S6), whether there is a command to stop sewing is determined (S7). If the user wants to stop sewing, the sewing start/stop switch 21 is operated. Therefore, this determination is made based on whether the sewing start/stop switch 21 is operated. If it is determined that there is a command to stop sewing (YES at S7), sewing and playing of the music data are stopped (S11) and the process proceeds to a determination as to whether there is a command to start sewing (S12). On the other hand, it is determined that there is no command to stop sewing (NO at S7), whether there is a command to change a color is determined (S8). A color-change timing to change a thread color is designated by the stitch data 53 in the embroidery data 50. When the color-change timing is encountered (YES at S8) and it is determined that there is a command change to change a color, both sewing and playing of music data are stopped (S11). Subsequently, whether there is a command to start sewing is determined (S12). If sewing and playing of music data are stopped before completion (S11) and the sewing start/stop switch 21 is operated again (YES at S12), sewing and playing of music data are started from the point at which they stopped (S5).

If no error has occurred (NO at S6), there is no command to stop sewing (NO at S7), and there is no command to change the color (NO at S8), whether playing the current music data has been completed is determined (S9). If it is determined that playing of the music data has been completed (YES at S9), the music data subsequent to the music data currently being played is read from the playlist (S13) and the process returns to S5. On the other hand, if playing of the music data has not been completed (NO at S9), whether sewing of the stitch data 53 has been completed is determined (S10). If it is determined that the sewing has not finished yet (NO at S10), the process returns to S5 and sewing and playing of music data continues. On the other hand, if it is determined that the sewing has been completed (YES at S10), the music data playing process is completed.

According to the sewing machine 1 of the present embodiment, the user selects the desired embroidery data 50 first. Then, music data that belongs to a category among a plurality of categories stored in the music data storage area 624 of the ROM 62 that matches the category information 52 added to the selected embroidery data 50 is extracted. Then, music data pieces to be played during sewing are selected from among the extracted music data and the order of the music data pieces to be played is automatically determined. Then the music data pieces are played in the determined order during sewing. That is, the user only needs to carry out simple operations of selecting the embroidery data 50 without performing complicated operations, in order to select music data that corresponds to the embroidery data 50. Since the user does not need to determine the order of the music data pieces to be played, the user can enjoy listening to the music that corresponds to the embroidery data 50 by simple operations. Also, music and sewing will be stopped together if the sewing is suspended before completion due to an error, color change, etc. The user is thus notified that sewing is being conducted when the music is played and that sewing is not being conducted when the music is not played.

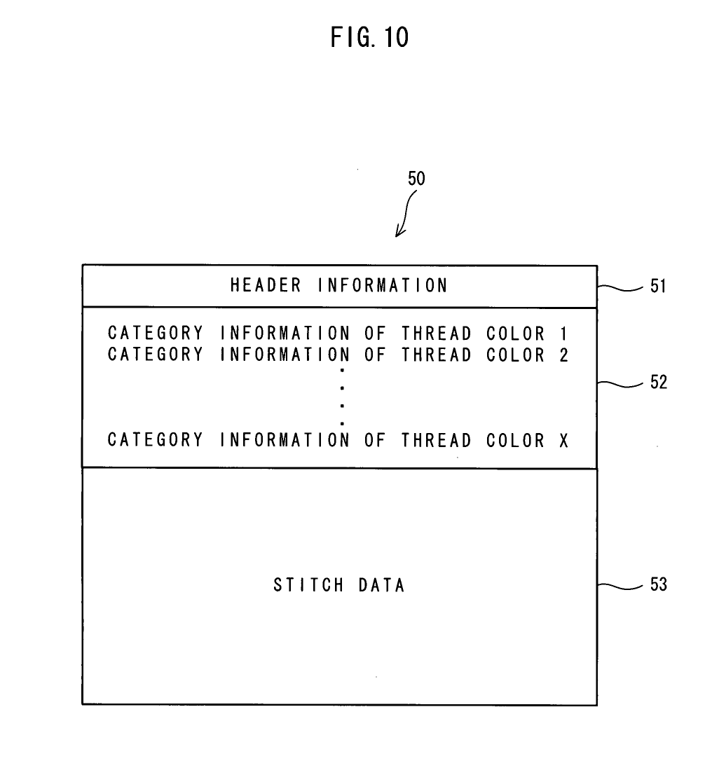

Next, a sewing machine 2 in accordance with an alternative embodiment of the present disclosure and its operations will be described with reference to FIGS. 10 through 12.

It should be noted that the sewing machine 2 is a variant of the sewing machine 1 of the previously described embodiment. Although sewing is conducted using the same embroidery data 50 of the sewing machine 1, a process to change music data to be played according to a category to which music data to be played belongs is performed in synchronization with sewing operations. More specifically, in this embodiment, each time a thread color is changed, music data which corresponds to a different category is played. Further, the sewing machine 2 of the present embodiment is the same as the sewing machine 1 of the previously described embodiment except for a format of the embroidery data 50 which is stored in an embroidery data storage area 623 in a ROM 62. Therefore, explanations of a constitution shown in FIGS. 1 through 3, storage areas of the ROM 62 shown in FIG. 4, and a music data storage area 624 in the ROM 62 shown in FIG. 6 are omitted.

First, the embroidery data 50 is stored in the embroidery data storage area 623 in the ROM 62 will be described with reference to FIG. 10. As shown in FIG. 10, the embroidery data 50 in the present embodiment is comprised of header information 51, category information 52, and stitch data 53. Category information 52 is further subdivided into X number of information corresponding to X number of thread colors. For each of the thread colors, category information is stored. Further, the stitch data 53 includes data required to form stitches on a work cloth and added information of sewing time required for sewing for each thread color.

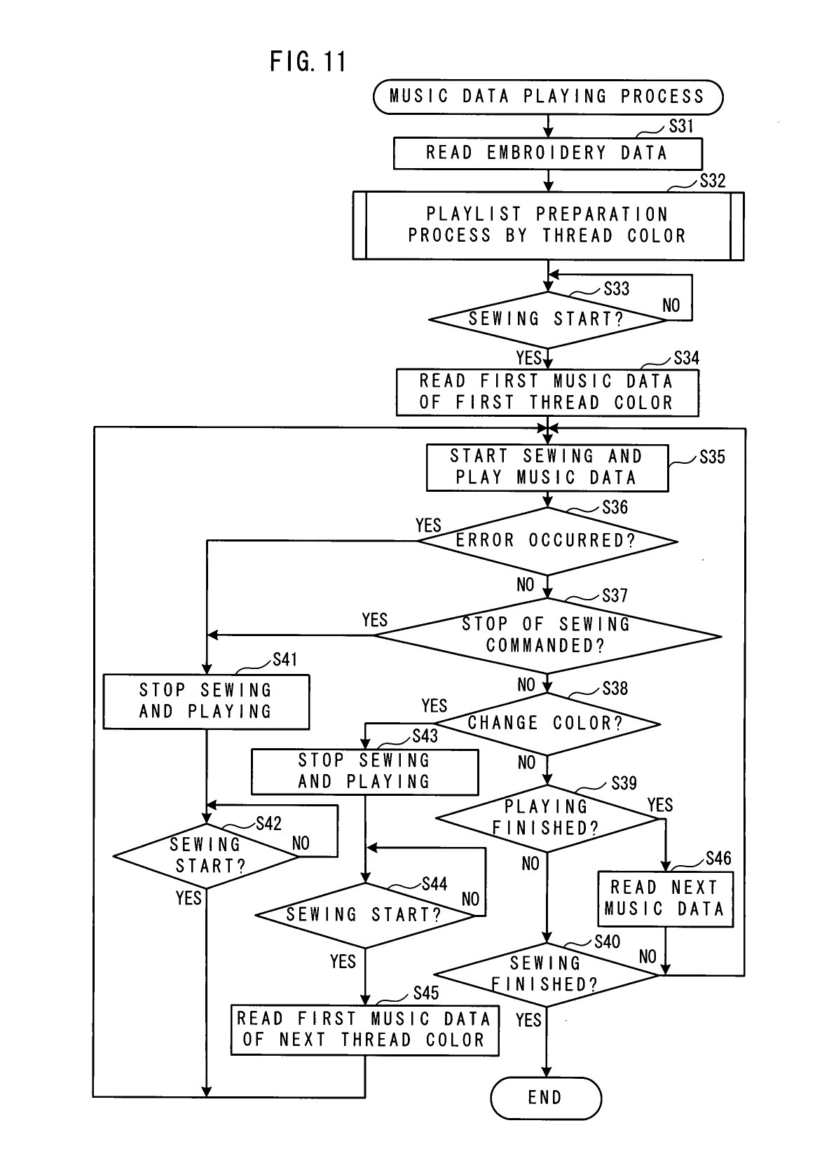

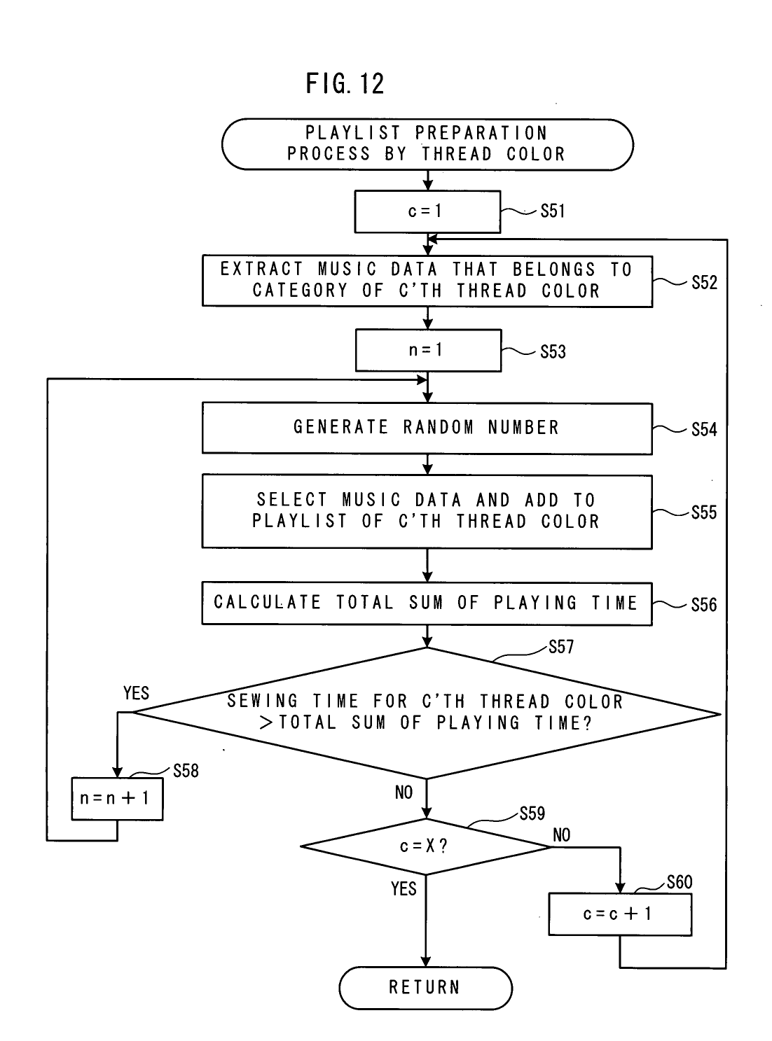

Next, operations performed by the sewing machine 2 will be described in detail with reference to FIGS. 11 and 12. If a user operates a touch panel 26 to select one of a plurality of embroidery data 50, a music data playing process shown in a flowchart of FIG. 11 is started. In the music data playing process, first, the stitch data 53 and the category data 52 in the embroidery data 50 selected by the user are read (S31). Then, a playlist preparation process by thread color is performed to determine the order of the music data to be played for each thread color (S32).

The following will describe in detail the playlist preparation process by thread color with reference to FIG. 12. As shown in the flowchart of FIG. 12, when the playlist preparation process by thread color starts, first, a value of a counter c indicating an order of a thread color among the X number of thread colors is initialized to an initial value of “1” (S51). Subsequently, music data that corresponds to the category information of the c'th thread color from among a plurality of categories stored in a music data storage area 624 in the ROM 62 is extracted (S52). With this, candidates for music data to be played during sewing of a thread having the c'th thread color are selected. Subsequently, the value of the counter n indicating the order of a music data piece in the playlist for the c'th thread color is initialized to the initial value of“1” (S53). Then a process to generate a random number is performed and the generated random number is stored in an RAM 63 (S54). One of the music data pieces contained in the extracted music data corresponding to the stored random number is selected and added to the playlist as music data to be played the n'th in the order during sewing of a thread having the c'th thread color (S55).

Subsequently, based on information of playing time added to the respective music data, a total sum of the playing time of all of the music data pieces added to the playlist for the c'th thread color is calculated (S56). Subsequently, whether the calculated total sum of the playing time is less than a sewing time for the c'th thread color is determined (S57). As described earlier, the information of the sewing time for the c'th thread color is already added to the stitch data 53 in the embroidery data 50 (see FIG. 10). If the total sum of the playing time is less than the sewing time (YES at S57), the counter n is incremented by one in order to add new music data to the playlist for the c'th thread color (S58) and the process returns to S54. The new music data is added to the playlist (S54-S56) until the total sum of the playing time is not less than the sewing time. If the total sum of the playing time is not less than the sewing time (NO at S57), whether the value of the counter c is equal to the number X of the thread colors is determined (S59). If the value of c is not equal to the value of X (NO at S59), the counter c is incremented by one (S60). Then, the process returns to S52, to create the playlist for the next thread color. If the value of c is equal to the value of X (YES at S59), this indicates that the playlist has been prepared for all of the thread colors and the playlist preparation process by thread color is completed. The process then returns to the music data playing process (see FIG. 11).

Subsequently, as shown in the flowchart of FIG. 11, whether there is a command to start sewing is determined based on whether a sewing start/stop switch 21 (see FIGS. 1 and 3) is operated (S33). If there is no command to start sewing (NO at S33), this determination is repeated until there is a command to start sewing (YES at S33), at which point the first music data in the playlist for the first thread color is read (S34). Then, sewing by use of the stitch data 53 is started and the music data is played through the speaker 40.

Subsequently, whether an error has occurred is determined (S36) and, if no error has occurred (NO at S36), whether there is a command to stop sewing is determined based on whether the sewing start/stop switch 21 is operated (S37). If an error has occurred (YES at S36) or if there is a command to stop sewing (YES at S37), sewing and playing of the music data are stopped (S41). Then, similarly to the determination of S33, whether there is a command to start sewing is determined (S42). If there is no command to start sewing (NO at S42) this determination is repeated until there is a command to start sewing (YES at S42), at which point the process returns to S35 to resume sewing and playing of music data from where they were stopped.

On the other hand, if no error has occurred (NO at S36) and there is no command to stop sewing (NO at S37), whether there is a command to change the color is determined (S38). The sewing machine is programmed beforehand so that a command to change the color is given at the timing to change the color of the thread. Therefore, if the command to change the color is given (YES at S38), sewing and playing of music data are stopped (S43). Then, similar to the determination of S33 and S42, whether there is a command to start sewing is determined (S44). If there is no command to start sewing (NO at S44), this determination (S44) is repeated until there is a command to start sewing (YES at S44), at which point the first music data in the playlist for the next thread color is read (S45) and the process returns to S35.

On the other hand, if there is no command to change the color (NO at S38), whether playing of the current music data has been completed is determined (S39). If it is determined that playing of the music data has been completed (YES at S39), the music data subsequent to the music data that was being played in the playlist for the same thread color is read (S46) and the process returns to S35. On the other hand, if it is determined that playing of the music data has not been completed (NO at S39), whether sewing by use of the stitch data 53 has been completed is determined (S40). If it is determined that sewing has not been completed (NO at S40), the process returns to S35 in order to continue sewing and playing of the music data. On the other hand, if it is determined that sewing has been completed (YES at S40), the music data playing process is completed.

As described above, in the sewing machine 2 of the present embodiment, if the user selects the desired embroidery data 50, a different category for each thread color is extracted and music data pieces to be played during sewing are selected from among these music data pieces corresponding to the category and the order of the music data pieces to be played is automatically determined. Once sewing is started, even in the case of sewing by use of the same embroidery data 50, each time the thread color changes, a different category of music is played. It is thus possible to play multimedia information of different categories in synchronization with operations of the sewing machine 2, in order to entertain the user by diversifying the multimedia information to be played during sewing.

Although in the sewing machine 2, the category to which music data to be played belongs, is changed for each thread color, the timing for changing the category is not limited. For example, in the embroidery data 50 that requires ten thousands stitches to complete the embroidery, the category information 52 may be classified every one thousand stitches to play music of a different category each time the sewing machine 2 makes one thousand stitches. To do so, whether the number of stitches has reached multiples of a thousand is determined and, if the number has reached multiples of a thousand, music data in accordance with the playlist for the next one thousand stitches is played. Also, music data to be played can be changed by use of various operations of the sewing machine 2.

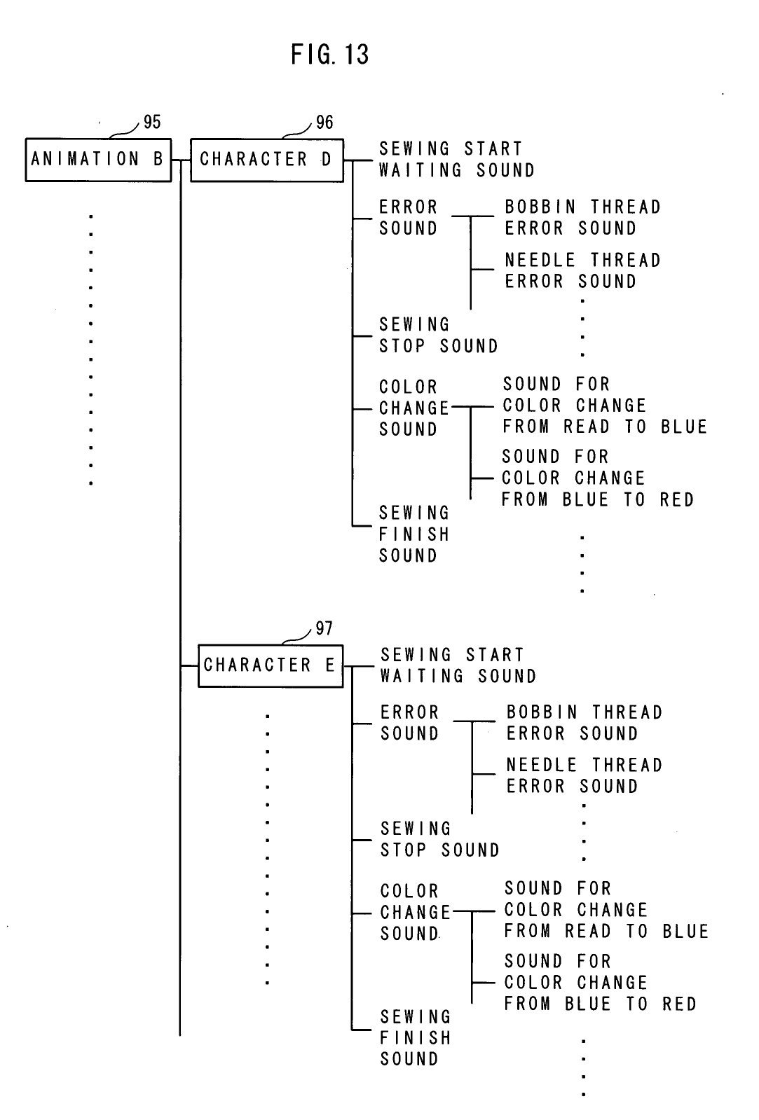

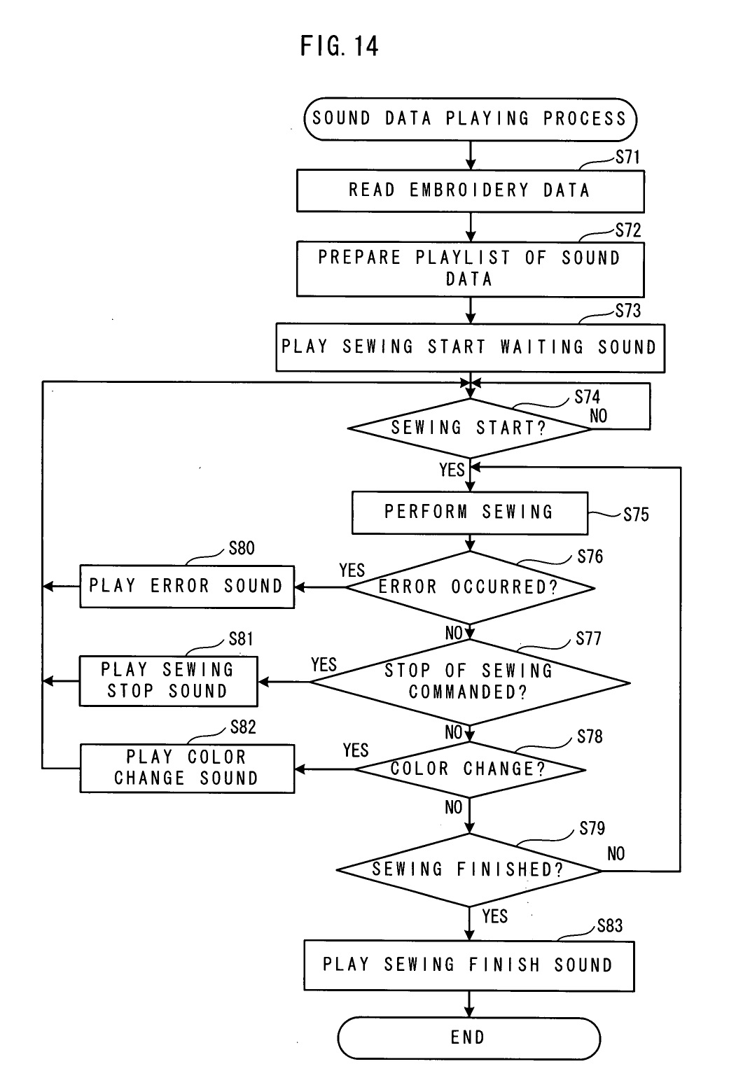

Next, a sewing machine 3 and its operations in accordance with an alternative embodiment of the present disclosure will be described with reference to FIGS. 13 and 14.

It should be noted that the sewing machine 3 can audibly notify of an operation procedure, progress of sewing, an error contents, and the like in synchronization with sewing operations by sound. It then performs a process to change sound data according to a category to which a sound belongs, corresponding to category information 52 in embroidery data 50. Since the sewing machine 3 employs the same structure as the sewing machine 1 of a previously described embodiment, explanation of a constitution shown in FIGS. 1 through 3, storage areas of a ROM 62 shown in FIG. 4, and a format of embroidery data shown in FIG. 5 are omitted.

First, examples are described of sound data stored in a sound data storage area 625 in a ROM 62 with reference to FIG. 13. As shown in FIG. 13, sound data, which is multimedia information, is classified into a plurality of categories and stored beforehand similar to music data. Moreover, a category 95 of animation B is classified into a plurality of categories for each of characters who appear in animation B, such as a category 96 of character D, a category 97 of character E, and the like. In association with the character-specific categories 96 and 97 thus classified, a variety of sounds that correspond to sewing operations of the sewing machine 3 are stored in the voice of each character, such as a sewing start waiting sound which prompts a user to start sewing, an error sound which notifies of an error, and the like. Moreover, some of the sounds such as the error sound are further subdivided into different contents, so that a plurality of category groups forming a hierarchal structure as shown in FIG. 13 are stored in the sound data storage area 625.

In the present embodiment, information that indicates a category of sound data is stored in the category information 52 in the embroidery data 50 (see FIG. 5) and the category information 52 is used to select a sound to be played through a speaker 40 (see FIGS. 2 and 3). For example, if “character D” is specified by the category information 52 added to the embroidery data 50 selected by the user, prior to start of sewing, a sound that prompts the user to start sewing is played in the voice of character D. Similarly, when sewing ends, a sound that notifies of ending of sewing is played in the voice of character D. That is, the category information 52 in the embroidery data 50 is associated with the categories stored in the sound data storage area 625.

Next, operations of the sewing machine 3 will be described in detail with reference to FIG. 14. If one of a plurality of embroidery data 50 is selected by the user, the sound data playing process indicated by the flowchart of FIG. 14 is started. In the sound data playing process, first, the stitch data 53 and category information 52 in the embroidery data 50 selected by the user are read (S71). The category information 52 contains information required to determine which category of sound is to be selected. This information is used to extract one of the categories of sound data stored in the sound data storage area 625 in the ROM 62. The sound data that corresponds to the category is used to create a playlist of sound data, which is used to play sound data that corresponds to sewing operations of the sewing machine 3 (S72).

Subsequently, the sound data of the sewing start waiting sound in the playlist is played (S73), and a sound of “Sewing is started by pressing the START button” is generated through the speaker 40. Then, whether there is a command to start sewing is determined based on whether a sewing start/stop switch 21 (see FIGS. 1 and 3) is operated (S74). If there is no command to start sewing, this determination (S74) is repeated until (NO at S74) there is a command to start sewing (YES at S74), at which point sewing is started by use of the stitch data 53 (S75).

Subsequently, whether an error has occurred is determined (S76) and, if an error has occurred (YES at S76), sound data that corresponds to the error that has occurred is played from among the error sound data in the playlist (S80). More specifically, for example, if the remaining quantity of a bobbin thread is scarce or if a needle thread is cut off, sounds of “Little bobbin thread remains” and “Check if needle thread is cut off” are generated through the speaker 40 respectively. Then, the process returns to the determination of S74 in which whether there is a command to start sewing is determined. On the other hand, if no error has occurred (NO at S76), whether there is a command to stop sewing is determined based on whether the sewing start/stop switch 21 is operated (S77). If there is a command to stop sewing (YES at S77), the sound data of a sewing stop sound in the playlist is played (S81), and a sound “Sewing is stopped” is generated through the speaker 40. Then, the process returns to the determination of S74.

On the other hand, if there is no command to stop sewing (NO at S77), whether there is a command to change the color is determined (S78). If a color-change command is given when the color-change timing is encountered (YES at S78), the sound data of a color-change sound in the playlist is played (S82). More specifically, for example, to change a thread color from red to blue, a sound “Sewing with red thread is finished. Set blue thread” is generated through the speaker 40. Then, the process returns to the determination of S74. On the other hand, if there is no command to change the color (NO at S78), whether sewing of the stitch data 53 has been completed is determined (S79). If it is determined that sewing has not been completed (NO at S79), the process proceeds to S75 and sewing is continued. On the other hand, if it is determined that sewing has been completed (YES at S79), the sound data of a sewing finish sound in the playlist is played (S83), generating a sound “Sewing is finished” through the speaker 40. Then, the process ends the sound data playing process.

As described above, in the sewing machine 3 of the presently described embodiment, if sewing is stopped, a sound is emitted to notify that sewing is stopped, so that the user can audibly know that sewing has stopped. Moreover, the sewing machine changes sound data according to the category to which sound data to be played belongs corresponding to the category information 52 in the embroidery 50, thereby enabling entertainment of the user by associating an embroidery pattern and a sound with each other. Although in the present embodiment a category is selected from the sound data storage area 625 in the ROM 62 (see FIG. 13) and then sound data is played that corresponds to that category, the operation is not limited to this. For example, by playing the error sound in the voice of character D and the sewing finish sound in the voice of character E, regardless of category, information that directly specifies sound data for each operation in the sewing machine 3 may be added to the category information 52 in the embroidery data 50.

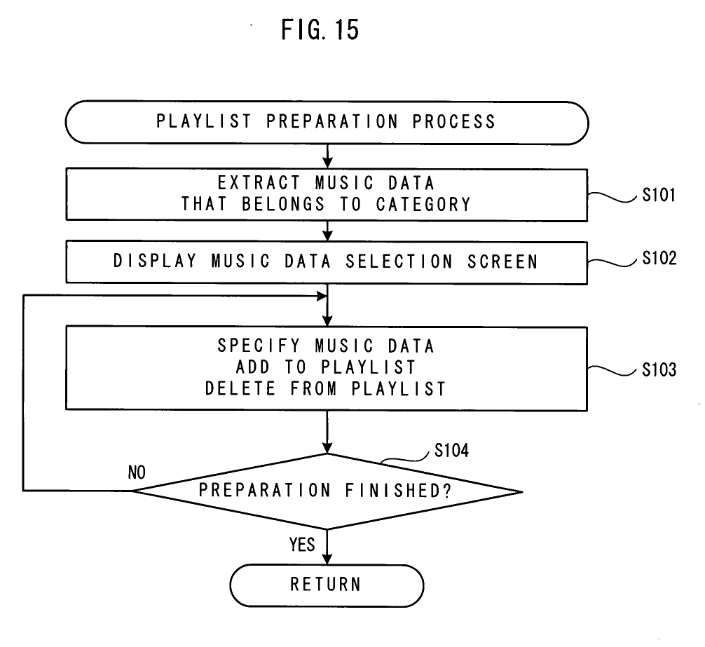

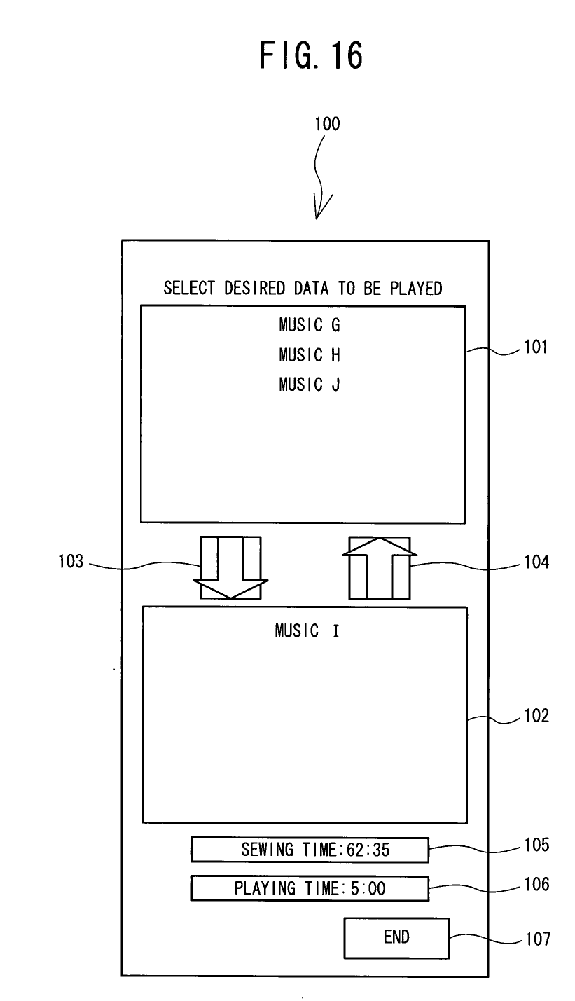

Next, a sewing machine 4 and its operations in accordance with an alternative embodiment of the present disclosure will be described with reference to FIGS. 15 and 16. It should be noted that the sewing machine 4 can play music data that corresponds to a category extracted by use of category information 52, in the order desired by a user. Also, the sewing machine 4 is a variant of a sewing machine 1 of a previously described embodiment. The operation of sewing machine 4 differs from the operation of sewing machine 1 in the previous steps of the playlist preparation process shown in FIG. 8. However, the music data playing process shown in FIG. 7, the structures of the sewing machines, and the like, are common to both and are thus, omitted in explanation.

As shown in FIG. 15, in the playlist preparation process which is performed by the sewing machine 4, first the music data that belongs to a category corresponding to the category information 52 added to the selected embroidery data 50 out of a plurality of categories stored in a music data storage area 624 in a ROM 62 is extracted (S101). Subsequently, a music data selection screen 100 appears on an LCD 15 (see FIG. 1) (S102). As shown in FIG. 16, the music data selection screen 100 includes an upper window 101 to display music data yet to be selected by the user out of the music data that belongs to an extracted category and a lower window 102 to display a playlist selected by the user. The music data selection screen 100 includes an ADD button 103 to add music data displayed in the upper window 101 to the playlist, a DELETE button 104 to delete music data from the playlist, and a sewing-time display portion 105 to display a sewing time. The music data selection screen 100 includes a playing-time display portion 106 to display a total sum of playing time of music data pieces added to the playlist and an END button 107 to end preparation of the playlist.

Subsequently, the music data desired by the user is specified out of the extracted music data (S103). This process is performed when the user operates a touch panel 26. First, if music data in the upper window 101 is specified, a display color of the specified music data changes. If the ADD button 103 is operated in this condition, the specified music data is deleted from the upper window 101 and then displayed in the lower window 102. Moreover, a total sum of playing time of the music data in the lower window 102 is calculated and then displayed at the playing-time display portion 106. Further, if the DELETE button 104 is operated in a condition where music data in the lower window 102 is specified and its display color is changed, the specified music data is deleted from the lower window 102 and then displayed in the upper window 101, and a total sum of playing time is calculated and then displayed at the playing-time display portion 106.

Subsequently, whether to end preparation of the playlist is determined based on whether the END button 107 is operated (S104). If the END button 107 is not operated (NO at S104), the process returns to S103 to prepare the playlist again. If the END button 107 is operated (YES at S104), the process ends the playlist preparation process and returns to the music data playing process shown in FIG. 7. It should be noted that music data will be played downward sequentially from the top to the bottom of the lower window 102 as long as a sewing time displayed at the sewing-time display portion 105 is yet to elapse.

As described above, the sewing machine 4 extracts a category that corresponds to the category information 52 in the embroidery data 50 from among a plurality of categories stored in the music data storage area 624 in the ROM 62. Then, music data that correspond to the extracted category are displayed as candidates in the upper window 101 of the music data selection screen 100. Therefore, only by selecting the embroidery data 50, candidates for music data adapted to that embroidery data 50 are selected automatically. It is thus possible to play the desired music easier than in the case of searching for the desired music from among a number of candidates including music data not adapted to the embroidery data 50 and determining the order of the music data to be played. Further, it is possible to play music data desired by the user out of those displayed as candidates in the order desired by the user, thereby giving the user greater control.

The present disclosure is not limited to the above-described embodiments and other embodiments are possible. Although embodiments of the present disclosure have been described in relation to music data and sound data the same process may be employed for still images and moving images, including a data storage form, a method for selecting data to be played, timings at which to start and stop playing, and the like. Therefore, the previously described embodiments can be applied to still images and moving images by categorizing still image data and moving image data and storing them in an image data storage area 626 in the ROM 62 and playing the data on the LCD 15.

In other embodiments, a moving image and a still image can be synchronized to the music and sound. For example, it is possible to play a moving image of character A on the LCD 15 when music of character A is being played from the speaker 40. Also, when a sound “Little bobbin thread is left”, and the like is being emitted from the speaker 40, a message screen to that effect can be displayed on the LCD 15.

Further, the previously described embodiments may be combined arbitrarily. For example, by combining the operations of sewing machine 1 with the operations sewing machine 3, a sewing machine in accordance with the present disclosure, will play music during sewing and stop the music if sewing is stopped and play a sound that notifies the user of operation conditions. Also, for example, by combining sewing machine 1 and sewing machine 4, the user may be permitted to select whether a playlist should be created automatically or by the user. In this case, it is possible to play multimedia information in accordance with the user's taste or mood.

Although in certain previously described embodiments music data pieces are added to a playlist in a determined order by using random number generation, the present disclosure is not limited to these embodiments. For example, it is possible to store the order in the ROM 62 beforehand or determine the order by using indexes added to each data. In the above-described embodiments, multimedia information is played in synchronization with operations of the sewing machine. In addition, for example, in alternative embodiments, playing of the multimedia information may be carried out when sewing is not being performed or the user may be permitted to select whether to play the multimedia information during sewing.

Although in the previously-described embodiments, the multimedia information, the sewing data, and the control program are stored in the ROM 62 in the control portion 60, the present disclosure is not limited to this. For example, other storage devices can be used such as an EEPROM 64, an HDD, a flash memory, and the like equipped in the sewing machine so that they can be replaced as required. Alternatively, an external storage device 39 (see FIG. 3) such as a memory card, a USB memory, a CD-ROM, or a DVD can be used. Further, data can be stored in an external computer 38 (see FIG. 3) or a server beforehand and loaded via a communication connector 36 (see FIG. 3) into the storage device in the sewing machine.

Further, the multimedia information categories such as shown in FIGS. 6 and 13 need not always be of a hierarchal structure but may be of a more complicated hierarchy structure than the illustrated example. The same data pieces may be stored corresponding to a plurality of categories or each data piece may be specified directly rather than having the categories specified by the category information 52. The user may directly specify a category of the multimedia information rather than specifying them by using the category information 52 in the embroidery data 50. The user may be permitted to set the category information 52 in the embroidery data 50 and a category of the multimedia information. For example, the user may be permitted to add to embroidery data of character F the category information 52 which corresponds to the category of multimedia information of character F when the embroidery data is downloaded.

Further, in the above-described embodiments, multimedia information is selected by using the CPU 61 in the sewing machine which determines the order in which to play data pieces and selects multimedia information to be played. Although the sewing machine has been equipped with a “multimedia information selection apparatus,” the present disclosure is not limited to this. For example, the sewing machine can be connected via the communication connector 36 (see FIG. 3) to the external computer 38, whereby the external computer 38 performs processing to select multimedia information.

What is claimed is:

1. A multimedia information selection apparatus comprising:
a memory that:
stores a plurality of multimedia information including at least one of sound information, moving image information, and still image information to be played in a sewing machine that performs sewing based on sewing data for forming stitches on a work cloth; and
stores the sewing data and unique information added for each of the sewing data; and
a controller that:
selects one of the sewing data stored; and
selects the multimedia information corresponding to the sewing data selected from among the plurality of multimedia information stored based on the unique information added to the selected sewing data.

2. The multimedia information selection apparatus according to claim 1, wherein:
the memory further stores correspondence between the multimedia information stored and the unique information added for each of the sewing data, and
the controller further selects the multimedia information by referencing the correspondence between the multimedia information and the unique information stored.

3. The multimedia information selection apparatus according to claim 1, wherein the controller further determines an order to play the multimedia information selected.

4. The multimedia information selection apparatus according to claim 1, wherein the controller further selects the multimedia information to be actually played from among the multimedia information selected.

5. A sewing machine comprising:
a multimedia information selection apparatus comprising:
a memory that:
stores a plurality of multimedia information including at least one of sound information, moving image information, and still image information to be played in a sewing machine that performs sewing based on sewing data for forming stitches on a work cloth, and
stores the sewing data and unique information added for each of the sewing data; and
a controller that:
selects one of the sewing data stored; and,
selects the multimedia information corresponding to the sewing data selected from among the plurality of multimedia information stored based on the unique information added to the selected sewing data;
a sewing device that forms the stitches on the work cloth; and
a playing device that plays the multimedia information;
wherein the controller:
controls the sewing device based on the sewing data selected; and
controls the playing device to play the multimedia information selected throughout the time the sewing device is being driven.

6. The sewing machine according to claim 5, wherein
the memory further stores correspondence between the multimedia information stored and the unique information added for each of the sewing data; and
the controller further selects the multimedia information by referencing the correspondence between the multimedia information and the unique information stored.

7. The sewing machine according to claim 5, wherein the controller further determines an order to play the multimedia information selected.

8. The sewing machine according to claim 5, wherein the controller further selects the multimedia information to be actually played from among the multimedia information selected.

9. The sewing machine according to claim 5, wherein the controller stops playing of the multimedia information being played by the playing device when the sewing device is stopped.

10. The sewing machine according to claim 5, wherein:
the controller:
selects stop multimedia information that indicates the sewing device is stopped; and
controls the playing device so that the playing device plays the stop multimedia information selected when the sewing device is stopped.

11. A multimedia information selection program encoded on a computer-readable medium, comprising instructions for:
selecting one sewing data for forming stitches on a work cloth; and
selecting multimedia information corresponding to the sewing data selected from among a plurality of multimedia information including at least one of sound information, moving image information, and still image information to be played in a sewing machine that performs sewing based on the sewing data, based on unique information added to the selected sewing data.

12. The multimedia information selection program according to claim 11, wherein the selecting of the multimedia information is performed by referencing correspondence between the multimedia information and the unique information.

13. The multimedia information selection program according to claim 11, further comprising instructions for:
determining an order to play the multimedia information selected.

14. The multimedia information selection program according to claim 11, further comprising instructions for:
selecting the multimedia information to be actually played from among the multimedia information selected.

15. A sewing machine program encoded on a computer-readable medium, comprising instructions for:
selecting one sewing data for forming stitches on a work cloth;
selecting multimedia information corresponding to the sewing data selected from among a plurality of multimedia information including at least one of sound information, moving image information, and still image information to be played in a sewing machine that performs sewing based on the sewing data, based on unique information added to the selected sewing data;
forming the stitches on the work cloth based on the sewing data selected; and
playing the multimedia information selected throughout the time the stitches are being formed.

16. The sewing machine program according to claim 15, wherein the selecting of the multimedia information is performed by referencing correspondence between the multimedia information and the unique information.

17. The sewing machine program according to claim 15, further comprising instructions for:
determining an order to play the multimedia information selected.

18. The sewing machine program according to claim 15, further comprising instructions for:
selecting the multimedia information to be actually played from among the multimedia information selected.

19. The sewing machine program according to claim 15, wherein playing of the multimedia information being played stops when the forming of the stitches is stopped.

20. The sewing machine program according to claim 15, further comprising instructions for:
selecting, when selecting multimedia information corresponding to the sewing data selected, stop multimedia information that indicates the forming of the stitches is stopped; and
playing the stop multimedia information selected when the forming of the stitches is stopped.
